(19) United States
(12) Patent Application Publication
(10) Pub. No.: US 2017/0339004 A1
(43) Pub. Date: Nov. 23, 2017

(54) Hub To Hub Repair of A Redundant Star Network

(71) Applicants: David R. Hall, Provo, UT (US); Mark D. Hall, Springville, UT (US); Craig Boswell, Draper, UT (US); Jedediah Knight, Provo, UT (US)

(72) Inventors: David R. Hall, Provo, UT (US); Mark D. Hall, Springville, UT (US); Craig Boswell, Draper, UT (US); Jedediah Knight, Provo, UT (US)

(21) Appl. No.: 15/156,729

(22) Filed: May 17, 2016

(51) Int. Cl. H04L 12/24; H04L 12/28; H04L 12/44; H04L 12/26

(52) U.S. Cl. CPC H04L 41/0668; H04L 43/0817; H04L 12/2838; H04L 12/44

(57) ABSTRACT

A redundant star network and methods for communicating over the network are disclosed. The network includes a peripheral device, a first network hub, and a second network hub. Each of the peripheral device, the first network hub, and the second network hub includes a wireless long range transceiver and at least one microcontroller. The first and second network hub microcontrollers store system operation information that includes instructions for operating the peripheral device and instructions for designating a peripheral device control hub. Additionally, the first and second network hub microcontrollers each include firmware for testing whether the other hub is operational and updating the system operation information to change the peripheral device control hub if it is non-operational. In some embodiments, the network is connected to a cloud server that communicates system updates to a user device.

### TECHNICAL FIELD

This invention relates generally to the field of home automation, and more specifically to network communication systems and control hub redundancy.

### BACKGROUND

Home and office automation is an ever-growing market focused on streamlining and simplifying user experiences at home and work. The products and services that can be included in home and office automation systems vary widely based on user need. Customizable lights, adaptive blinds and thermometers, remotely controlled entry points, smart door locks, smart refrigerators, and smart washers are just a few products available and designed with the purpose of improving a user's life while at home and work. However, these products and services are limited by the wired and wireless communication networks of which they are a part. An automated home or office is dependent on the ensured and enduring functionality of the network and control hubs to which these devices connect. When the network or control hub fails, the user is left with the challenge of non-functioning devices, including entry point access and smart door lock leading to potential security and access issues.

### SUMMARY OF THE INVENTION

A home automation redundant network communication system is disclosed that overcomes or improves upon the limitations discussed above. In general, the system consists of two or more network hubs. Each network hub includes short and long-range wireless transceivers and microcontrollers to periodically test and update the network hubs. In the case that one network hub does not respond to the test signals, the other, or any of the other, network hubs will become the device control hub for peripheral devices previous controlled by the non-responsive network hub until such time as the network control hub becomes responsive again. Hub redundancy allows for ensured and enduring functionality of a home automation system. In the case of one network hub becoming non-responsive and/or non-functioning, the tasks of that network hub will be rerouted to a second network control hub, ensuring that the user can continue to control the peripheral device via their home automation network. The system also includes, in some embodiments, a cloud server that is networked to one or more network hubs of a home automation system. The cloud server stores the system operation information for the network, which can be accessed by a user via a smartphone, tablet, or computer. The user is notified via the server when a control hub is non-functional and/or when control for one or more peripheral devices has switched hubs.

In one embodiment, the system includes a peripheral device, a first network hub, and a second network hub. The peripheral device includes a wireless long range transceiver and a microcontroller, and is controlled wirelessly by a control hub. The first network hub and second network hub each have a wireless long range transceiver and a microcontroller that stores system operation information. The system operation information includes instructions for operating the peripheral device and instructions for designating the peripheral device control hub. Additionally, the first microcontroller includes second network hub test firmware and first network hub update firmware. The second network hub test firmware instructs the first network hub to send a second network hub test signal and to listen for a second network hub test response signal. The first network hub update firmware instructs the first microcontroller to update the system operation information to designate the first network hub as the peripheral device control hub when the second network hub test response signal is not received within an expected response timeframe after the second network hub test signal is sent. Similarly, the second microcontroller includes first network hub test firmware and second network hub update firmware. The first network hub test firmware instructs the second network hub to send a first network hub test signal and to listen for a first network hub test response signal. The second network hub update firmware instructs the second microcontroller to update the system operation information to designate the second network hub as the peripheral device control hub when the first network hub test response signal is not received within an expected response timeframe after the first network hub test signal is sent.

In another embodiment, the system includes a peripheral device, a central network hub, and two or more additional network hubs. The peripheral device includes a wireless long range transceiver and a microcontroller, and is controlled wirelessly by a control hub. The first network hub and two or more additional network hubs each have a wireless long range transceiver and a microcontroller that stores system operation information. The system operation information includes instructions for operating the peripheral device and instructions for designating a peripheral device control hub. Additionally, the system operation information includes instructions for designating a new central network hub. The central network hub microcontroller includes network hub test firmware that instructs the central network hub to send a test signal designated for a current peripheral device control hub and instructions that instruct the first network hub to listen for a current peripheral device control hub test response signal. The central network hub microcontroller also includes peripheral device control hub update firmware that instructs the central network hub microcontroller to update the system operation information to designate a new peripheral device control hub from among the two or more additional network hubs when the current network hub test response signal is not received within an expected response timeframe after the current peripheral device control hub test signal is sent. The additional network hub microcontrollers include central network hub test firmware and additional network hub update firmware. The central network hub test firmware instructs the additional network hub to send a central network hub test signal designated for the central network hub and instructions that instruct the additional network hub to listen for a central network hub test response signal corresponding to the central network hub. The additional network hub update firmware instructs the additional microcontroller to update the system operation information to designate the additional network hub as the new central network hub when the central network hub test response signal is not received within an expected response timeframe after the central network hub test signal is sent.

### BRIEF DESCRIPTION OF THE DRAWINGS

A more particular description of the invention briefly described above is made below by reference to specific embodiments. Several embodiments are depicted in drawings included with this application, in which:

FIG. 1 depicts one embodiment of a redundant star network according to the claimed invention.

FIGS. 2A-C depict another embodiment of a redundant star network.

FIGS. 3A-C depict an embodiment a redundant star network connected to a cloud.

FIGS. 4A-E depict an embodiment of a redundant star network having more than two hubs, where one hub controls operation of the others.

FIGS. 5A-C depict an embodiment of a redundant star network having more than two hubs, where one hub controls operation of the others, and where the control hub is connected to a cloud.

FIG. 6 depicts a specific embodiment of a redundant star network for an access-controlled multi-building industrial complex.

FIG. 7 depicts another specific embodiment of a redundant star network for an access-controlled multi-building industrial complex.

FIG. 8 depicts an example embodiment of a method for communicating over a redundant star network.

FIG. 9 depicts another example embodiment of a method for communicating over a redundant star network.

### DETAILED DESCRIPTION

A detailed description of the claimed invention is provided below by example, with reference to embodiments in the appended figures. Those of skill in the art will recognize that the components of the invention as described by example in the figures below could be arranged and designed in a wide variety of different configurations. Thus, the detailed description of the embodiments in the figures is merely representative of embodiments of the invention, and is not intended to limit the scope of the invention as claimed.

In some instances, features represented by numerical values, such as dimensions, mass, quantities, and other properties that can be represented numerically, are stated as approximations. Unless otherwise stated, an approximate value means “correct to within 50% of the stated value.” Thus, a length of approximately 1 inch should be read “1 inch+/−0.5 inch.”

All or part of the present invention may be embodied as a system, method, and/or computer program product. The computer program product may include a computer readable storage medium (or media) having computer readable program instructions thereon for causing a processor to carry out aspects of the present invention. For example, the computer program product may include firmware programmed on a microcontroller. As used herein, “microcontroller” refers to any combination of hardware memory and hardware processors suitable for the system and methods described herein. For example, in some embodiments, a microcontroller is a 256 kb-RAM microcontroller. In other embodiments, the microcontroller is a 64 kb-RAM microcontroller. In yet other embodiments, the hardware memory and hardware processors are networked on a PCB, where the hardware memory has megabytes to terabytes of memory, and where the hardware processors include processing speeds of 1 MHz to 16 GHz.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, a chemical memory storage device, a quantum state storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming languages such as Smalltalk, C++ or the like, and conventional procedural programming languages such as the “C” programming language or similar programming languages. Computer program code for implementing the invention may also be written in a low-level programming language such as assembly language.

In some embodiments, electronic circuitry including, for example, programmable logic circuitry, field-programmable gate arrays (FPGA), or programmable logic arras (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. Those of skill in the art will understand that each block of the flowchart illustrations and/or block diagrams, and combinations of blocks in the flowchart illustrations and/or block diagrams, may be implemented by computer readable program instructions. Additionally, those of skill in the art will recognize that the system blocks and method flowcharts, though depicted in a certain order, may be organized in a different order and/or configuration without departing from the substance of the claimed invention.

These computer readable program instructions may be provided to a processor of a general purpose computer, special purpose computer, embedded system, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

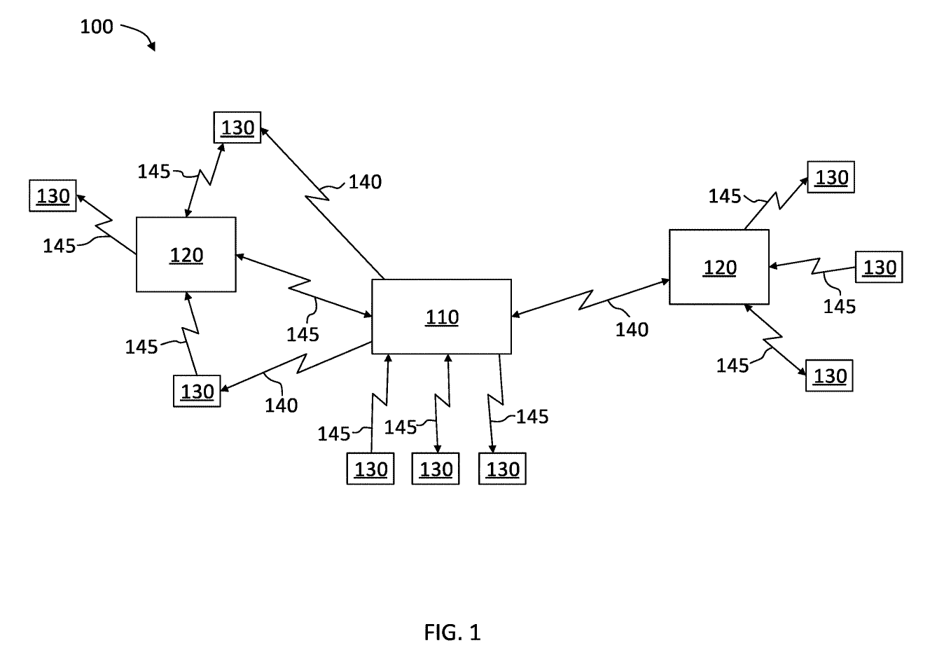

FIG. 1 depicts one embodiment of a redundant star network 100 according to the claimed invention. Redundant star network 100 includes primary network hub (PNH) 110, one or more secondary network hubs (SNH) 120 located remotely from PNH 110, and one or more peripheral devices (PD) 130. The PDs 130 are located remotely from the PNH 110 and the SNH 120. PNH 110 has one or more wireless Long range transceivers and one or more microcontrollers having communication firmware for long range spread spectrum (SS) and narrowband frequency shift keying (FSK) signal communication via the PNH Long range transceiver. SNH 120 similarly has one or more wireless Long range transceivers and one or more microcontrollers having communication firmware for long range SS and narrowband FSK signal communication via the SNH Long range transceiver. PD 130 also has, in one embodiment of redundant star network 100, an actuation mechanism, at least one wireless Long range transceiver and at least one corresponding microcontroller having communication firmware for long range SS and narrowband FSK signal communication via the PD 130 Long range transceiver. In another embodiment, PD 130 has an actuation mechanism, at least one wireless receiver and at least one corresponding microcontroller having receive firmware for long range SS and narrowband FSK signal communication. In yet another embodiment, PD 130 has an actuation mechanism, at least one wireless transmitter and at least on corresponding microcontroller having transmit firmware for long range SS and narrowband FSK signal communication.

Though only a few PDs 130 are depicted, in some embodiments, redundant star network 100 includes several more PDs 130. For example, in one embodiment, PNH 110 is networked to up to 128 PDs 130. In the same and/or other embodiments, SNH 120 is networked to up to 64 PDs 130.

As used throughout the claims and specification, long range means any range from 0.5 to 30 miles. In some embodiments, long range means approximately 1 mile. In other embodiments, long range means ranging from 1 to 26 miles. In yet other embodiments, long range means approximately 10 miles.

PNH 110, SNH 120, and/or PD 130 communicate via long range SS signals 140 and/or narrowband FSK signals 145 based on a range between communicating devices. For example, in one embodiment, PNH 110 communicates with one PD 130 via long range SS signals 140 and with a second PD 130 via narrowband FSK signals 145. In such an example, this configuration would be particularly beneficial where the first PD 130 is outside a PNH-PD narrowband FSK communication range but within a PNH-PD long range SS communication range. In another embodiment, a PD 130 is mobile. PNH 110 communicates with PD 130 via narrowband FSK signals 145 when PD 130 is within the PNH-PD narrowband FSK range, and via long range SS signals 140 when PD 130 is outside the PNH-PD narrowband FSK range. In another embodiment, PNH 110 communicates with PD 130 via long range SS signals 140 even when PD 130 is within the PNH-PD narrowband FSK range. Though not shown, in some embodiments, PNH 110 and SNH 120 communicate via a wired connection, such as an Ethernet communication link.

Many PDs are controlled by instructions consisting of hundreds of bits to hundreds of kilobits of data. Such instructions thus do not need to be communicated over high-data rate networks, thus decreasing the power consumed in transmitting and receiving information. Rather, low-data instructions can be transmitted via a low-data rate signal while still having a fast response time, such as within one second. This is particularly important for battery-operated PDs. PD 130 is, in some embodiments, such a PD, where PD 130 is battery-operated and is controlled by instructions consisting of hundreds of bits to hundreds of thousands of bits. In one embodiment, PD 130 requires from 100 bits to 500 kilobits of data for instruction. In this embodiment, long range SS signals 140 communicate instructions to PD 130 at a rate from 100 bits per second (bps) to 500 kilobits per second (kbps). In another embodiment, PD 130 requires from 200 bits to 300 kilobits of data for instruction. In this other embodiment, long range SS signals 140 communicate instructions to PD 130 at a rate from 200 bps to 300 kbps. In yet another embodiment, PD 130 requires from 1 to 100 kilobits of data for instruction. In this embodiment, long range SS signals 140 communicate instructions to PD 130 at a rate from 1 to 100 kbps.

In one example, PNH 110 communicates with SNH 120 via long range SS signals 140. SNH 120 processes communications from PNH 110 and forwards information to PD 130 via narrowband FSK signals 145. Similarly, in another embodiment, SNH 120 receives information from PNH 110 via narrowband FSK signals 145, processes the information, and forwards information to PD 130 via long range SS signals 140. As another example, communication between PNH 110, SNH 120 and PD 130 is accomplished via solely long range SS signals 140 or solely narrowband FSK signals 145.

Long range SS signals 140 are any time of spread spectrum signal. For example, in one embodiment, long range SS signals 140 are long range spread spectrum frequency hopping (SSFH) signals. In another embodiment, long range SS signals 140 are long range direct-sequence spread spectrum (DSSS), time-hopping spread spectrum (THSS), or chirp spread spectrum (CSS) signals. Other embodiments include combinations of two or more of SSFH, DSSS, THSS, and/or CSS signals. In embodiments comprising SSFH, DSSS, THSS, and/or CSS signals, the microcontrollers described above include firmware having instructions for communicating using these signals. For example, in one embodiment, the PNH microcontroller firmware includes instructions for long range SSFH signal communication. In the same or another embodiment, the SNH microcontroller firmware similarly includes instructions for long range SSFH signal communication. Additionally, in the same or other embodiments, the PD microcontroller firmware includes instructions for long range SSFH signal communication. In one embodiment, the microcontroller firmware of the PNH, SNH and PD all include instructions for long range SSFH signal communication.

In one embodiment, each SNH 120 is associated with a particular group of PDs 130, where each PD 130 is associated with only one SNH 120. PNH 110 stores high-level system operation information and instructions. The system operation information and instructions include operation instructions for SNHs 120 and PDs 130, and information about which PD 130 is associated with which SNH 120. PNH 110 transmits operation information and instructions to each SNH 120 for that hub only and its associated PDs. SNH 120 stores the operation information and instructions sent by PNH 110 and transmits and/or receives information, including instructions, to and/or from its associated PDs 130. Thus, PNH 110 acts as a system-wide control hub, and SNHs 120 act as local control hubs. This embodiment allows for robust communication with many devices while avoiding the interference and lag time of a single-hub system.

PD 130 may be any of a variety of apparatuses that include an actuation mechanism. In one embodiment, PD 130 is a gate for an access-controlled enclosure. For example, the enclosure, in one embodiment, is a perimeter fence surrounding a property such as a business, home, industrial complex, prison, or other access-controlled enclosures. In another embodiment, PD 130 is a door for allowing access to a structure or room within a structure. In one embodiment, PD 130 is a climate-control device, such as an HVAC system, for adjusting heating and cooling output inside a building. In yet another embodiment, PD 130 is an automated blind system and/or a light switch and/or system of light switches. PD 130 is also, in some embodiments, any of various household appliances, such as a refrigerator, stove, oven, dishwasher, clothes washing machine, clothes dryer, toilet, bath and/or shower, and kitchen appliances. In other embodiments, PD 130 is a personal computer, a printer/scanner, a fax machine and/or a telephone.

PD 130 is also, in some embodiments, any of a variety of commercial and/or industrial equipment. For example, in one embodiment, PD 130 is an elevator. In another embodiment, PD 130 is one of a variety of manufacturing equipment, such as a conveyor belt, a pump, a sensor, a motor, and/or a 3D printer. In yet other embodiments, PD 130 is a vehicle and/or a vehicle component such as a starter or a motor. In one embodiment, PD 130 is a drone.

Redundant star network 100 is a stand-alone network that offers several benefits. First, redundant star network 100 operates independently of the Internet. Thus, PNH 110 can communicate with each SNH 120 and PD 130 even when an external Internet connection is down. Additionally, in some embodiments of redundant star network 100, PNH 110, SNHs 120 and PDs 130 are equipped with backup power. The backup power is, in some embodiments, local, such as a battery. In the same or other embodiments, the backup power is an off-grid power source such as a generator or batteries. In such embodiments, connectivity between PNH 110, SNHs 120 and PDs 130, and operability of each, continues through a grid-power outage.

An additional benefit of the stand-alone dual modulation network described above is inherent security. In order for a device to interpret a long range SS signal, it must know which frequencies to check. In redundant star network 100, each of PNH 110, SNHs 120 and PDs 130 are programmed with a unique frequency sequence for redundant star network 100. External observers not aware of the unique frequency sequence would interpret the signals from redundant star network 100 as noise, even if the observer were trying to intercept signals from redundant star network 100. For added security, PNH 110, SNHs 120 and PDs 130 include, in some embodiments, tamper firmware that notifies an authorized user that the device has been tampered with before an unauthorized user can obtain the frequency sequence, automatically changes the frequency sequence, and updates other devices on the network with the new frequency sequence. For example, PNH 110 receives a tamper signal from PD 130. PNH 110 changes the frequency sequence and updates SNHs 120 and other PDs 130 with the new sequence. PNH 110 then notifies an authorized user that PD 130 has been tampered with and the frequency sequence has been updated.

The foregoing PD 130 embodiments described are examples only, and are not to be construed as limiting the scope of PD 130. Rather, PD 130 is any device or system that includes an actuation mechanism that performs a tangible function, such as turning a light in a room on or off, unlocking and/or opening a gate, and opening and/or closing blinds.

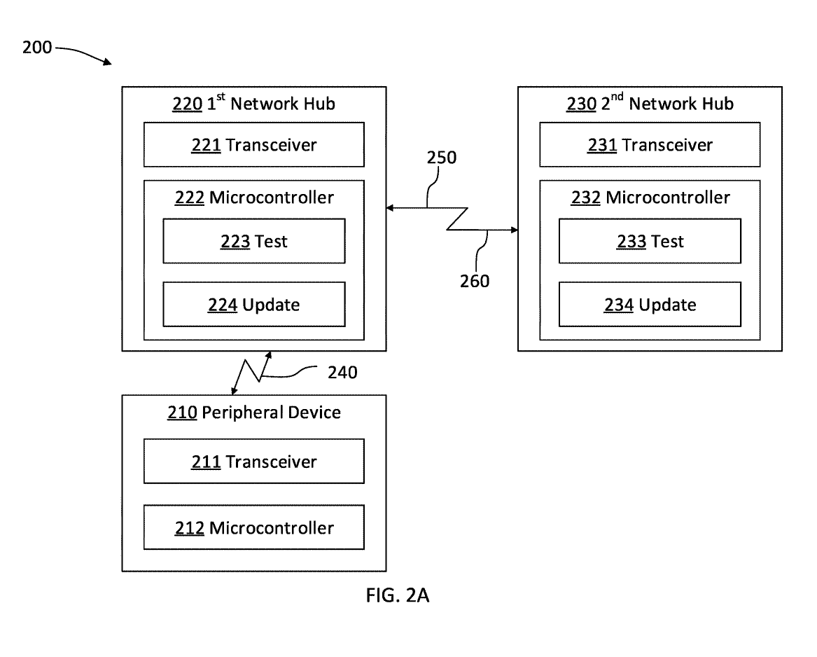

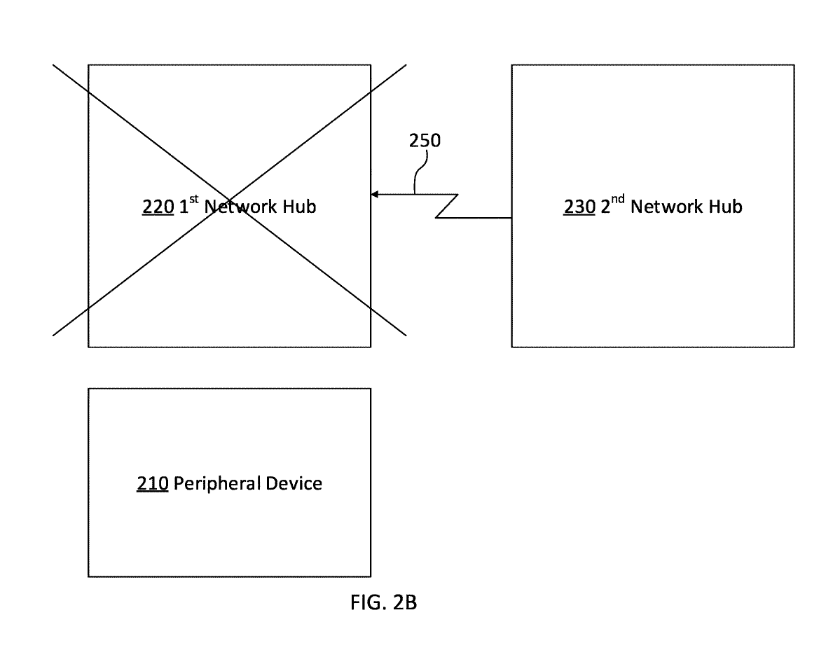

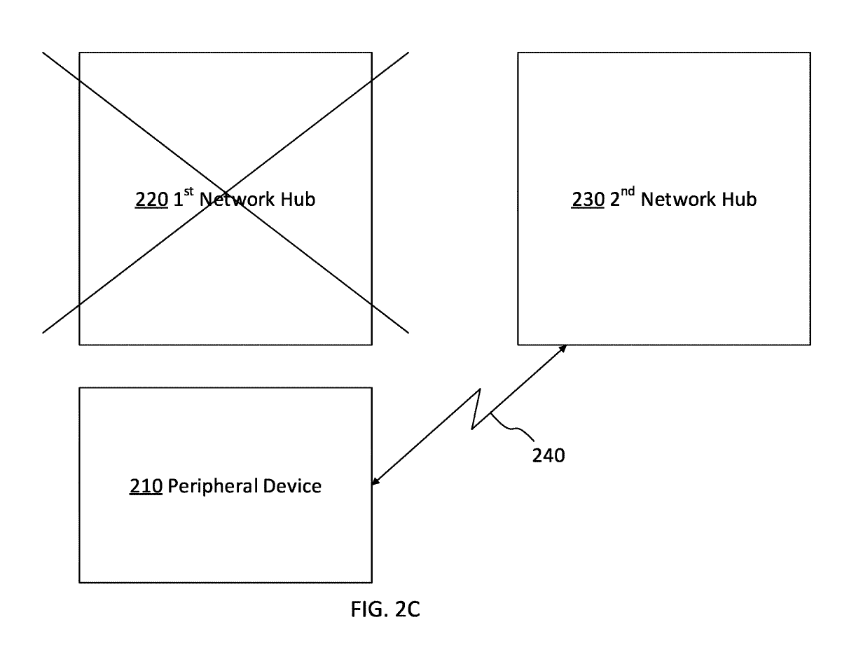

FIGS. 2A-C depict another embodiment of a redundant star network, such as redundant star network 200. As depicted in FIG. 2A, redundant star network 200 includes PD 210, first network hub 220, and second network hub 230. Though only one PD 210 is depicted, redundant star network 200 includes, in some embodiments several PDs 210, similar to that described with regard to FIG. 1. PD 210 has wireless long range transceiver 211 and microcontroller 212. Additionally, PD 210 is controlled wirelessly by a PD control hub. In the depicted embodiment, first network hub 220 controls PD 210 via wireless signals 240. First network hub 220 includes wireless long range transceiver 221 and microcontroller 222. Microcontroller 222 stores system operation information for redundant star network 200. The system operation information includes instructions for operating PD 210 and instructions for designating the PD control hub. Similarly, second network hub 230 includes wireless long range transceiver 231 and microcontroller 232 that stores the system operation information.

In some embodiments, one or more of microcontroller 212, microcontroller 222, or microcontroller 232 include instructions for communicating long range spread spectrum signals, narrowband frequency shift keying signals, or both, as described above with regard to FIG. 1.

In addition to the system operation information, microcontroller 222 includes second network hub test firmware 223 and first network hub update firmware 224. Test firmware 223 instructs first network hub 220 to send a second network hub test signal, designated for second network hub 230, to test whether second network hub 230 is operational. Test firmware 223 additionally instructs first network hub 220 to listen for a second network hub test response signal, which, for example, indicated second network hub 230 is operational. Update firmware 224 instructs microcontroller 222 to update the system operation information to designate first network hub 220 as the PD control hub when the second network hub test response signal is not received within an expected response timeframe after the second network hub test signal is sent. For example, in one embodiment, first network hub 220 transmits, via transceiver 221, the test signal designated for second network hub 230. First network hub 220 listens for the test response signal indicating second network hub 230 is operational for an expected response timeframe after the second network hub test signal is sent. For example, the timeframe is double an average timeframe of past responses, in one embodiment. In another embodiment, the timeframe is double the longest timeframe for a past response. In other embodiments, the timeframe is a pre-programmed timeframe. For example, the timeframe ranges from 100 nanoseconds to 5 seconds in one embodiment. In another embodiment, the timeframe ranges from 0.1 seconds to 3 seconds. In yet another embodiment, the timeframe is 2 seconds.

Similar to microcontroller 222, microcontroller 232 includes first network hub test firmware 233 and second network hub update firmware 234. Test firmware 233 instructs second network hub 230 to send a first network hub test signal, designated for first network hub 220, to test whether first network hub 220 is operational. Test firmware 233 additionally instructs second network hub 230 to listen for a first network hub test response signal, which, for example, indicates first network hub 220 is operational. Update firmware 234 instructs microcontroller 232 to update the system operation information to designate second network hub 230 as the PD control hub when the first network hub test response signal is not received within an expected response timeframe after the first network hub test signal is sent.

The redundancy between first network hub 220 and second network hub 230 allows for continuous control of PDs, such as PD 210, even when one hub goes down. For example, in the depicted embodiment, first network hub 220 is the PD control hub. Periodically, second network hub 230 sends test signals 250 to first network hub 220. For example, in some embodiments, second network hub 230 sends test signals 250 to first network hub 220 every 1 to 5 seconds. In some embodiments, second network hub 230 sends test signals 250 to first network hub 220 every 100 nanoseconds to 1 second. In some embodiments, second network hub 230 sends test signals 250 to first network hub 220 when a user prompts second network hub 230 to send test signals 250. When it is operational, first network hub 220 sends test response signals 260 to second network hub 230. Upon receiving test response signals 260, second network hub 230 prevents execution of update firmware 234.

FIG. 2B depicts an embodiment where first network hub 220 becomes non-operational. In such an embodiment, second network hub 230 sends test signals 250 to first network hub 220, but first network hub 220 fails to send test response signals 260 (not shown). As depicted in FIG. 2C, second network hub 230 updates the system operation information to designate second network hub 230 as the PD control hub. When the system operation information is updated, second network hub 230 controls PD 210.

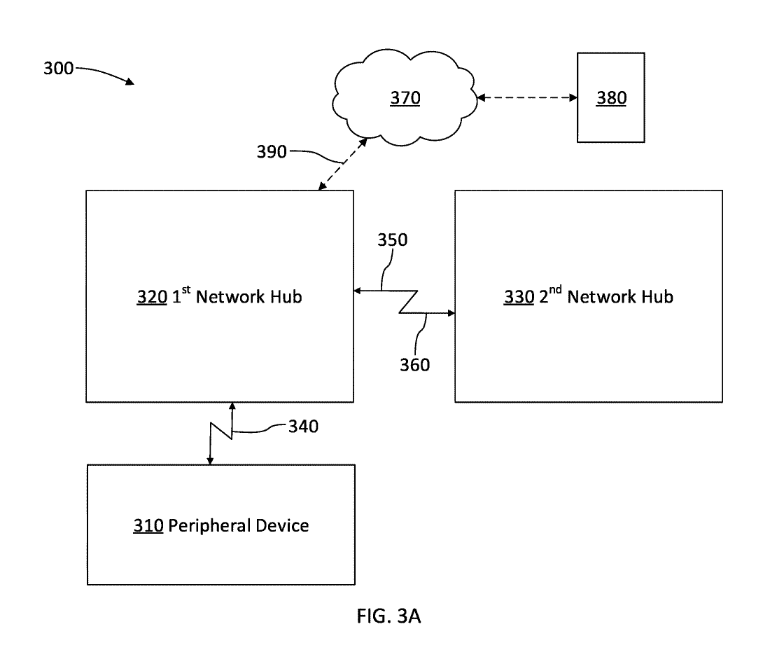

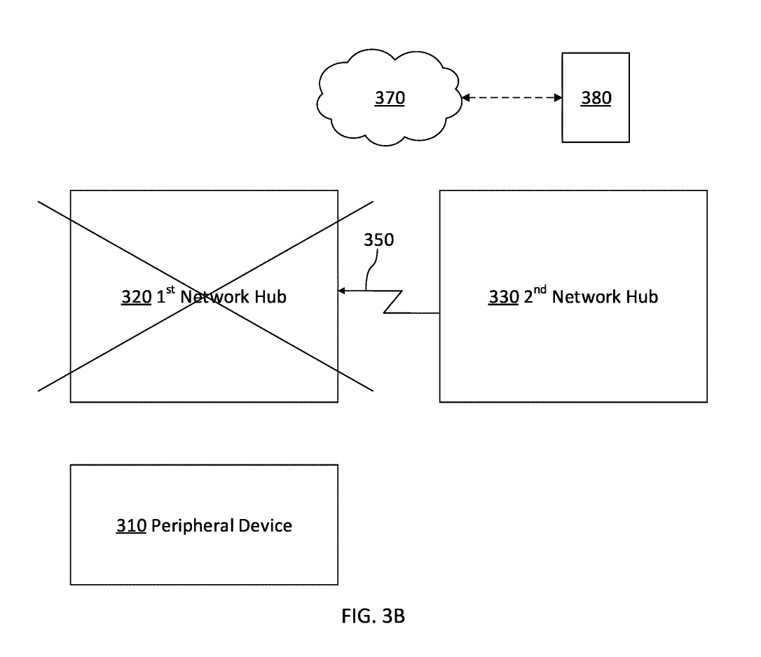

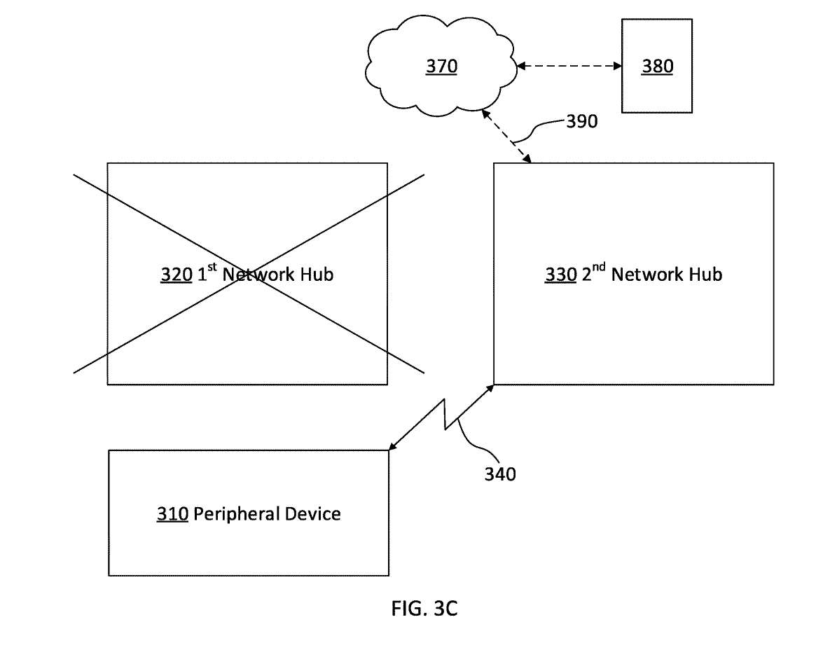

FIGS. 3A-C depict a redundant star network, redundant star network 300, system similar to redundant star network 200. As depicted in FIG. 3A, redundant star network 300 includes PD 310, first network hub 320, and second network hub 330. Additionally, redundant star network 300 includes server 370 and user device 380. Server 370 is one among a cloud of servers, and is networked to the first network hub, the second network hub, or both via wired network connection 390. Though not shown, server 370 includes hardware memory that stores the system operation information. The system operation information includes instructions that instruct first network hub 320 to notify server 370 the second network hub test response, as described with regard to FIG. 2A, is not received, and to notify server 370 that first network hub 320 is designated as the PD control hub. The system operation information also includes instructions that instruct server 370 to notify a user via user device 380 the second network hub test response is not received, and to notify the user via user device 380 that first network hub 320 is designated as the PD control hub.

The system operation information includes similar instructions for second network hub 330 in the event that first network hub 320 goes down. The system operation information includes instructions that instruct second network hub 330 to notify server 370 the first network hub test response, as described with regard to FIG. 2A, is not received, and to notify server 370 that second network hub 320 is designated as the PD control hub. The system operation information also includes instructions that instruct server 370 to notify the user via user device 380 the first network hub test response is not received, and to notify the user via user device 380 that second network hub 320 is designated as the PD control hub.

FIG. 3B depicts an embodiment where first network hub 320 becomes non-operational. In such an embodiment, second network hub 330 sends test signals 350 to first network hub 320, but first network hub 320 fails to send test response signals 360 (shown in FIG. 3A). Additionally, in some embodiments, first network hub 320 stops communicating with server 370. As depicted in FIG. 2C, second network hub 330 updates the system operation information to designate second network hub 330 as the PD control hub. When the system operation information is updated, second network hub 330 controls PD 310. Second network hub 330 communicates a failed test notice to server 370 and an updated control status to server 370 via wired connection 390 and, in some embodiments, server 370 forwards the failed test notice and updated control status to user device 380. In some embodiments, server 370 forwards the failed test notice and updated control status when user device 380 requests such information.

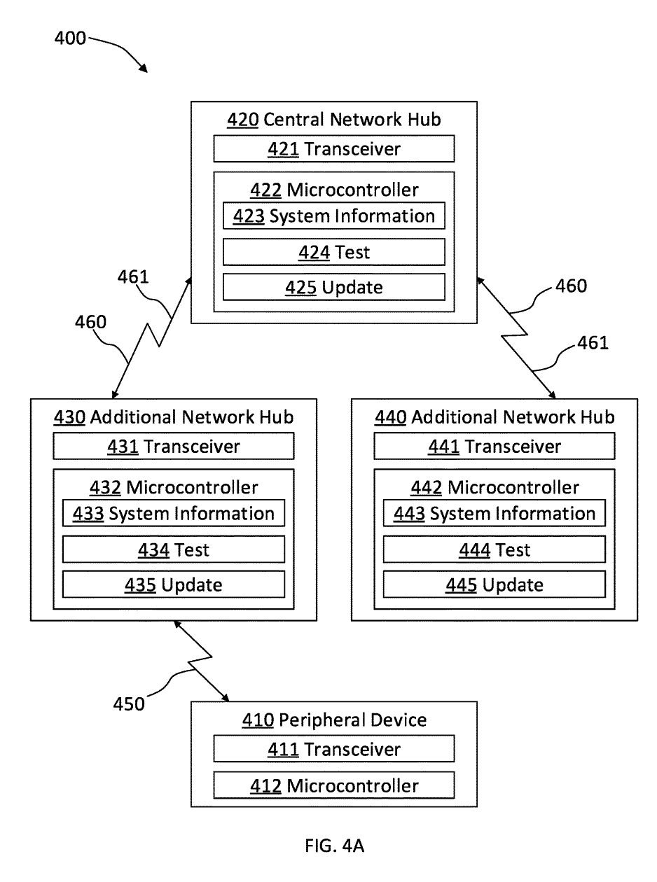

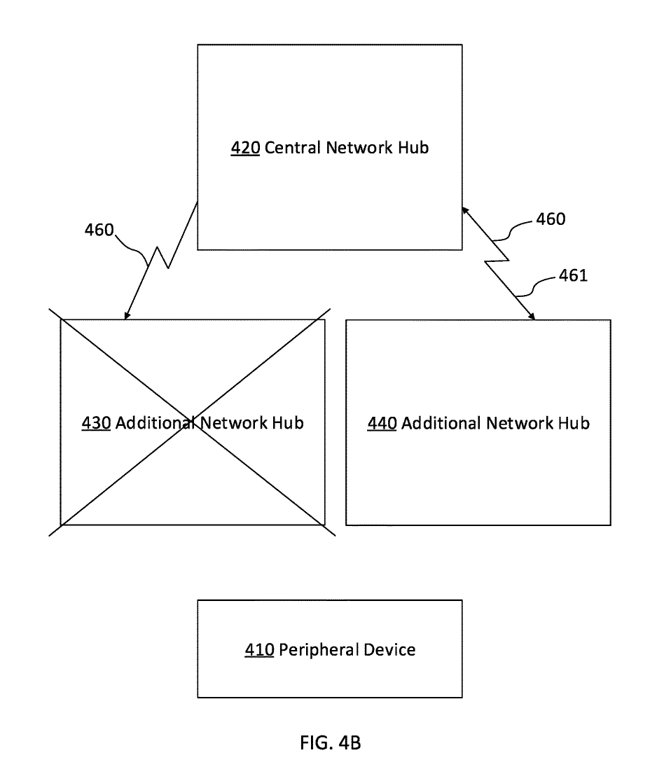

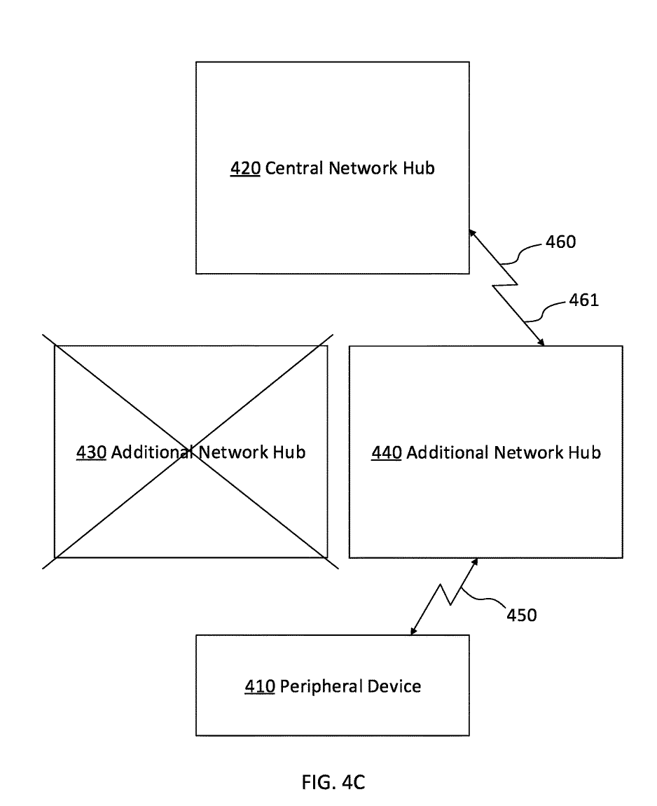

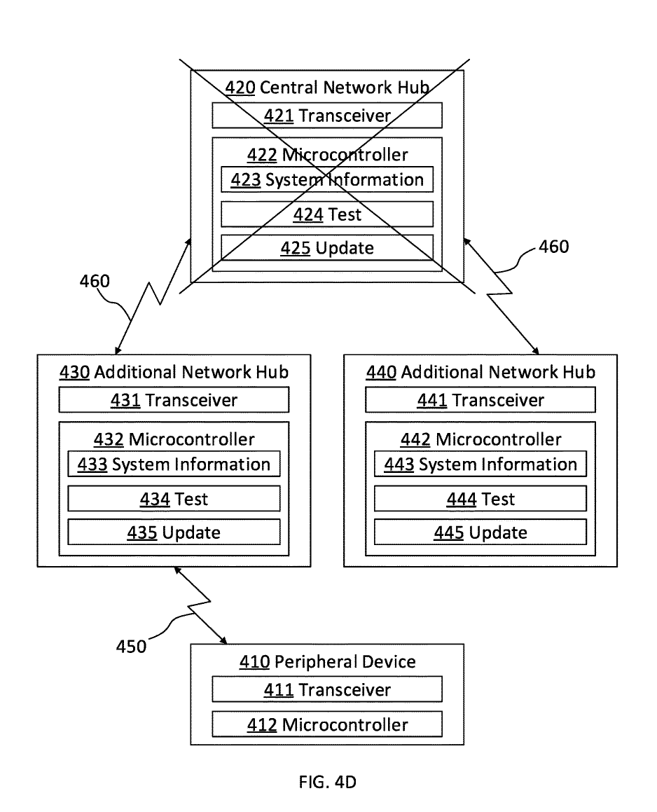

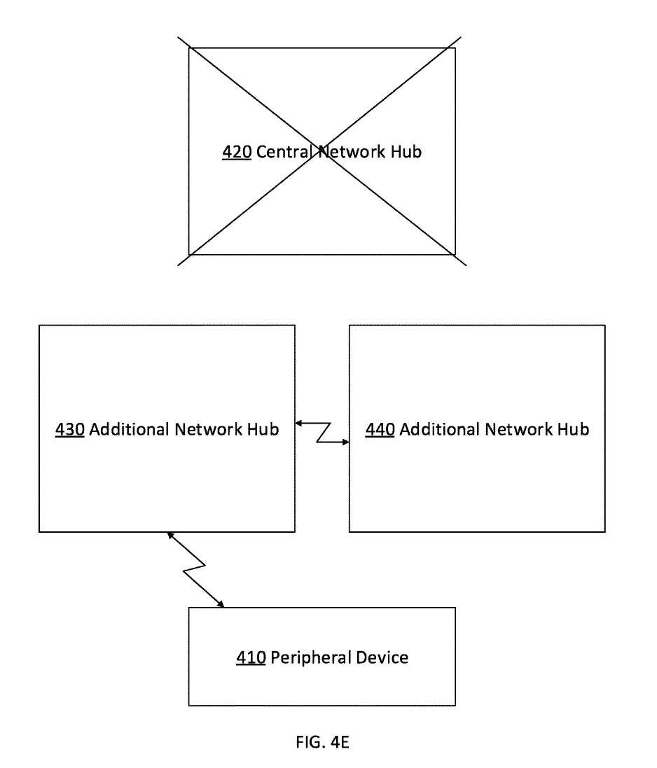

FIGS. 4A-E depict an embodiment of a redundant star network having more than two hubs, where one hub controls operation of the others. As depicted in FIG. 4A, redundant star network 400 includes PD 410, central network 420, and additional network hubs 430, 440. Though only one PD 410 is depicted, redundant star network 400 includes, in some embodiments, several PDs 410, similar to as described with regard to FIG. 1. Additionally, though only two are depicted, in some embodiments, redundant star network 400 includes more than two additional network hubs. PD 410 includes wireless long range transceiver 411 and microcontroller 412. Additionally, PD 410 is controlled wirelessly by a PD control hub. For example, as depicted, PD 410 is controlled by additional network hub 430 via wireless control signals 450. Central network hub 420 includes wireless long range transceiver 421 and microcontroller 422. Similarly, additional network hubs 430, 440 include wireless long range transceivers 431, 441 and microcontrollers 432, 442. Microcontrollers 421, 431, 441 store system operation information 423, 433, 443. System operation information 423, 433, 443 includes instructions for operating PD 410, instructions for designating a PD control hub and instructions for designating a new central network hub for cases when central network hub 420 becomes non-operational.

In some embodiments, one or more of microcontroller 412, microcontroller 422, or microcontrollers 433, 443 include instructions for communicating long range spread spectrum signals, narrowband frequency shift keying signals, or both, as described above with regard to FIG. 1.

Setting up a system to include a central control hub with additional control hubs provides several benefits. First, the central control hub monitors the additional control hubs for functionality. When one hub goes down, the central control hub efficiently transfers control of the PDs associated with the downed hub to another control hub. Second, as will be described more below, the central control hub centralizes communication with servers and user devices outside the redundant star network. This improves the security of the network by limiting the number of entry points. These and additional benefits not discussed, but inherent in the system, will be recognized by one of skill in the art.

In addition to the system operation information, microcontroller 422 includes network hub test firmware 424 and PD control hub update firmware 425. Test firmware 424 instructs central network hub 420 to send a test signal designated for a current PD control hub, such as additional network hub 430, to test whether the current PD control hub is operational. Test firmware 424 additionally instructs central network hub 420 to listen for a current PD control hub test response signal, which, for example, indicates the current PD control hub is operational. Update firmware 425 instructs microcontroller 422 to update the system operation information to designate a new PD control hub from among additional network hubs 430, 440 when the current PD control hub test response signal is not received within an expected response timeframe after the current PD control hub test signal is sent. For example, as in the depicted embodiment, central network hub 420 transmits, via transceiver 421, test signal 460 designated for additional network hub 430, which controls PD 410. Central network hub 420 listens, for an expected response timeframe after test signal 460 is sent, for test response signal 461 indicating additional network hub 430 is operational. In some embodiments, central network hub 420 simultaneously tests, via test signals 460, each additional network hub 430, 440 to determine whether, in the event one additional network hub fails, the other additional network hub can take over as the PD control hub for the PDs 410 associated with the failed hub.

FIG. 4B depicts an embodiment where additional network hub 430, which is the PD control hub, becomes non-operational. In such an embodiment, central network hub 420 sends test signals 460 to additional network hubs 430, 440, but only additional network hub 440 sends test response signal 461; additional network hub 430 fails to send test response signal 461. Central network hub 420 updates the system operation information to designate additional network hub 440 as the PD control hub. As depicted in FIG. 4C, when the system operation information is updated, additional network hub 440 controls PD 210 via control signals 450.

FIG. 4D depicts an embodiment where central network hub 420 becomes non-operational. Test firmware 434, 444 instructs additional network hubs 430, 440 to send test signals 460 designated for central network hub 420, and to listen for test response signals 461 (not shown) corresponding to central network hub 420. Update firmware 435, 445 instructs microcontrollers 432, 442 to update system operation information 433, 443 to designate one of additional network hubs 430, 440 as a new central network hub when test response 461 is not received within an expected timeframe after test signal 460 is sent. The timeframe is similar to the timeframe described above with regard to FIG. 2A. For example, as depicted in FIG. 4E, update firmware 435, 445 designates additional microcontroller 430 as the new central control hub.

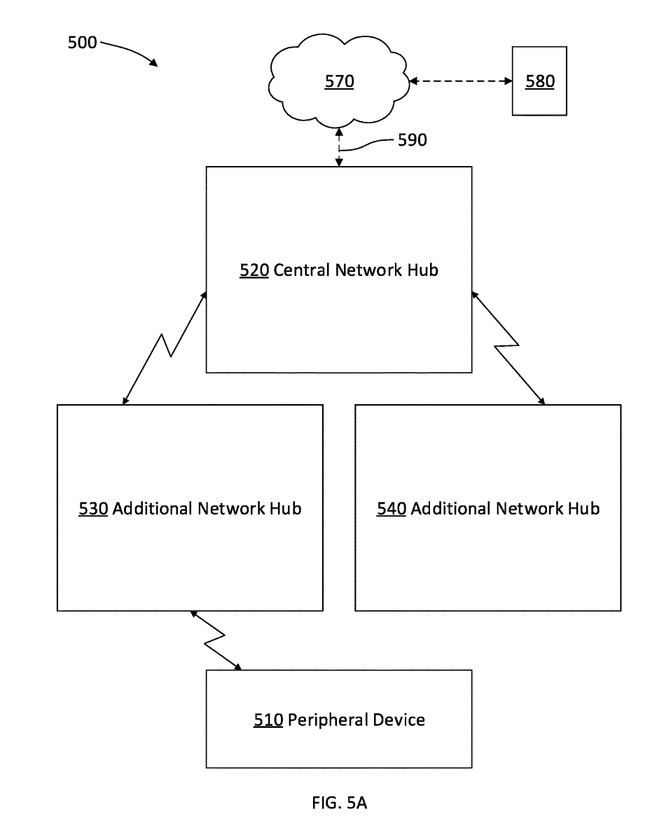

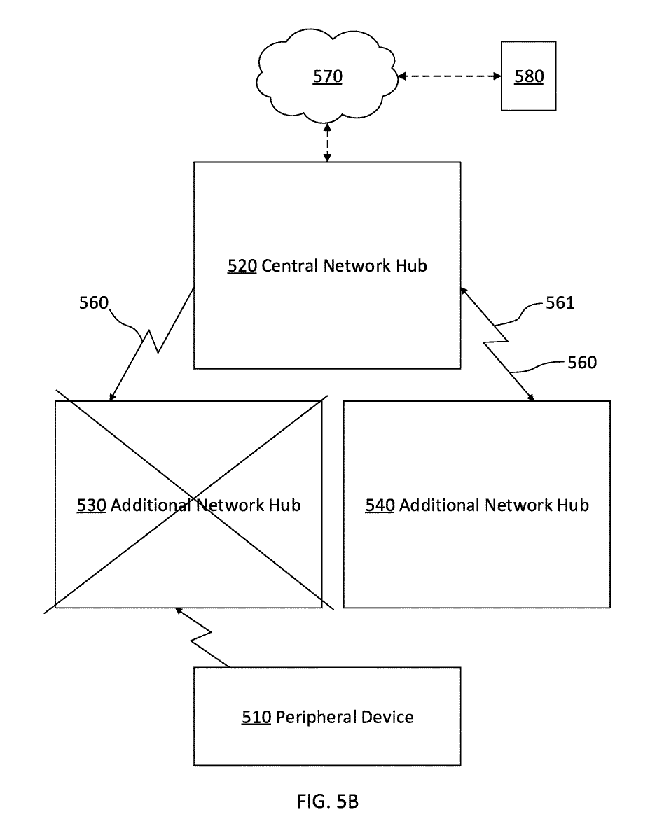

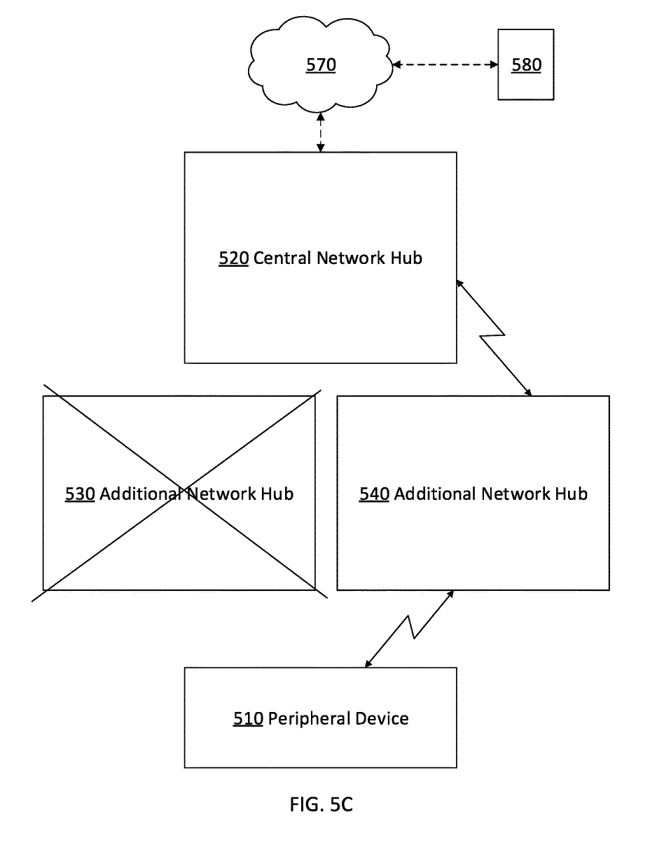

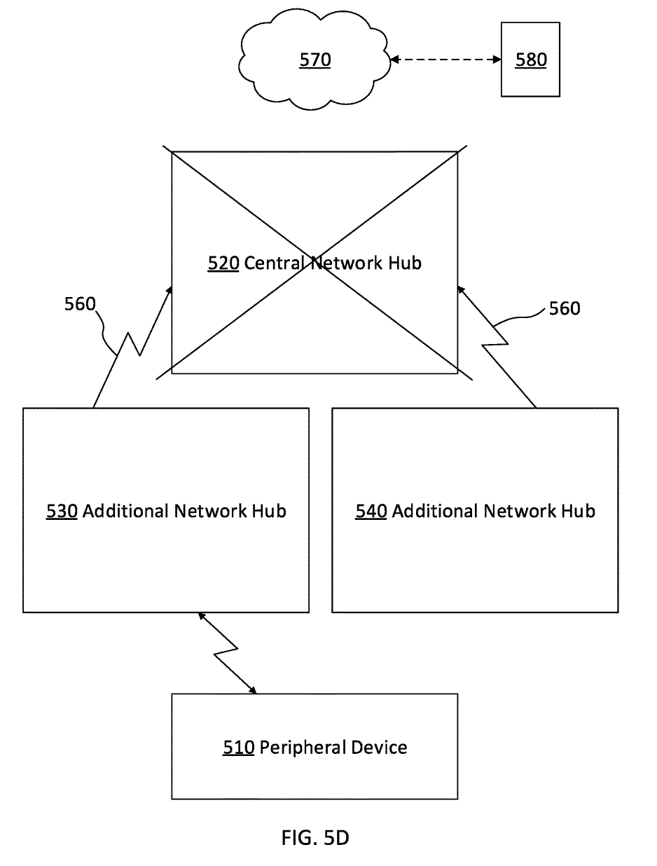

FIGS. 5A-C depict a redundant star network, redundant star network 500, similar to redundant star network 400. As depicted in FIG. 5A, redundant star network 500 includes PD 510, central network hub 520, and additional network hubs 430, 440. Additionally, redundant star network 500 includes server 570 and user device 580. Server 570 is one among a cloud of servers, and is networked to central network hub 520, one or more of additional network hubs 530, 540, or each of central network hub 520 and additional network hubs 530, 540 via wired network connection 590. Though not shown, server 570 includes hardware memory that stores the system operation information. The system operation information includes instructions that instruct central network hub 520 to notify server 570 the current PD control hub test response, as described with regard to FIG. 4A, is not received, and to notify server 570 that a new PD control hub is designated. The system operation information also includes instructions that instruct server 570 to notify a user via user device 580 the current PD control hub test response is not received, and to notify the user via user device 580 that the new PD control hub is designated.

The system operation information also includes instructions that instruct one or more of additional network hubs 530, 540 to notify server 570 the central network hub test response, as described with regard to FIG. 4A, is not received, and to notify server 570 that one of the additional network hubs 530, 540 is designated as the new central network hub. The system operation information also includes instructions that instruct server 570 to notify the user via user device 580 the central network hub test response is not received, and to notify the user via user device 580 that one of the additional network hubs 530, 540 is designated as the new central network hub.

FIG. 5B depicts an embodiment where additional network hub 530, which is the PD control hub, becomes non-operational. In such an embodiment, central network hub 520 sends test signals 560 to additional network hub 530, and in some embodiments, also additional network hub 540. Additional network hub 530 fails to send test response signals 561, whereas additional network hub 540 sends test response signals 561. As depicted in FIG. 5C, central network hub 520 updates the system operation information to designate additional network hub 540 as the PD control hub. Alternatively, additional network hub 540 updates the system operation information designating additional network hub 540 as the PD control hub. When the system operation information is updated, additional network hub 540 controls PD 510. Central network hub 520 communicates a failed test notice to server 570 and an updated control status to server 570 and, in some embodiments, server 570 forwards the failed test notice and updated control status to user device 580.

FIG. 5D depicts an embodiment of redundant star network 500 where central network hub 520 fails. In such an embodiment, additional network hubs 530, 540 send test signals 560 to central network hub 520. Central network hub 520 fails to send test response signals 561. Additionally, in some embodiments, central network hub 520 does not communicate with server 570. As depicted in FIG. 5E, one or more of the additional network hubs 530, 540 updates the system operation information to designate one of the additional network hubs 530, 540 as the new central network hub. For example, as depicted, additional network hub 540 is designated as the new central network hub. When the system operation information is updated, new central network hub 540 tests additional network hubs for functionality, such as additional network hub 530, and similar to that described above with regard to central network hub 520. Additional network hub 540 communicates a failed test notice to server 570 and an updated control status to server 570 via wired network connection 590 and, in some embodiments, server 570 forwards the failed test notice and updated control status to user device 580. In some cases, new central network hub 540 is not initially networked to server 570. In some such cases, new central network hub 540 is manually networked to server 570 by, for example, connecting wired network connection 590 to new central network hub 540.

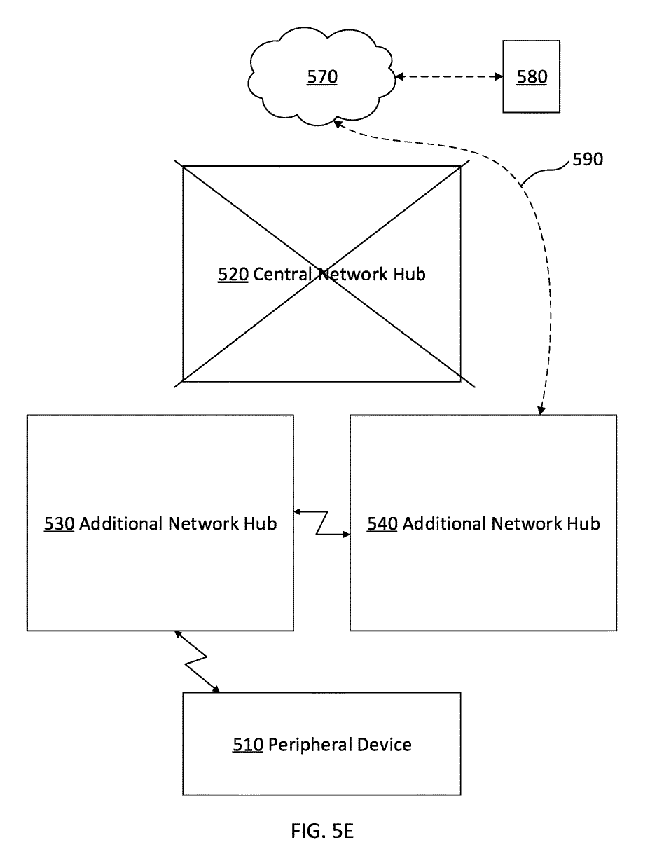

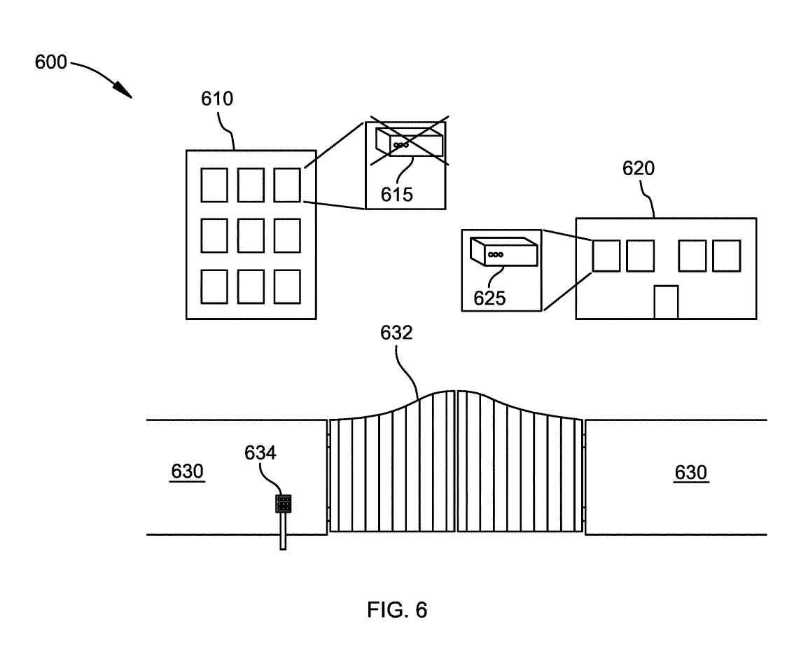

FIG. 6 depicts a specific embodiment of a redundant star network such as a network for an access-controlled multi-building industrial complex. Industrial complex 600 includes building 610, which houses network hub 615, and building 620, which houses network 625. Industrial complex 600 is surrounded by perimeter fence 630. Perimeter fence 630 includes a PD which controls access to industrial complex 600. In the present embodiment, the PD includes an access pad 634. Access pad 634 includes a Long range transceiver and microcontroller as described for PDs above.

A multi-hub redundant star network is useful for centralizing control of many devices located remotely around an industrial complex. In the depicted example, network hubs 615, 625 store system operation information for all locally networked devices around industrial complex 600. However, each network hub 615, 625 is assigned specific PDs based on, for example, location of the PD, whether the PD is mobile, and obstruction level between the network hub and the PD. When one network hub fails, another network hub takes over control of the PDs associated with the failed network hub. For example, as depicted, network hub 615, which controls access pad 624, becomes non-operational. Network hub 625 tests network hub 625, discovers network hub 615 is non-operational, and updates the system operation information to designate network hub 625 as the PD control hub for access pad 634. In this embodiment, control of access pad 634 is not lost despite the failure of network hub 615.

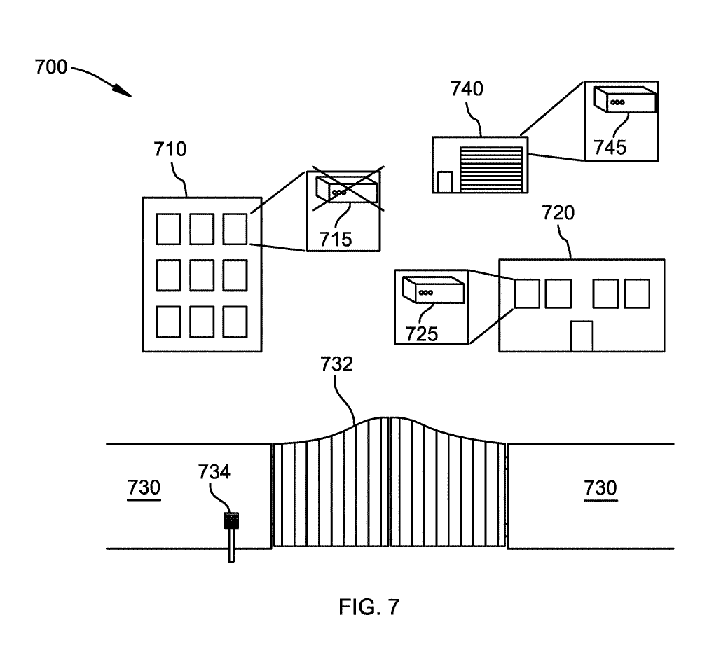

FIG. 7 depicts another specific embodiment of a redundant star network similar to FIG. 6. Industrial complex 700 includes building 710, which houses network hub 715, building 720, which houses network hub 725, and building 730, which houses network hub 745. In the depicted embodiment, network hub 715 is a central network hub, and tests network hubs 725, 745 for functionality. However, network hub 715 fails. Network hubs 725, 745 are notified of the failure, for example, when not tested as expected by central network hub 715. One of network hubs 725, 745 updates the system operation information to take over as a new central network hub and continues testing the other network hub. In one embodiment, the system operation information includes instructions for choosing, among the remaining network hubs, which network hub is the new central network hub. For example, the instructions, in one embodiment, include choosing the new central network hub based on nearest proximity to the failed central network hub. Or, the instructions include, in another embodiment, choosing the new central network hub based on a nearest average proximity to all networked PDs

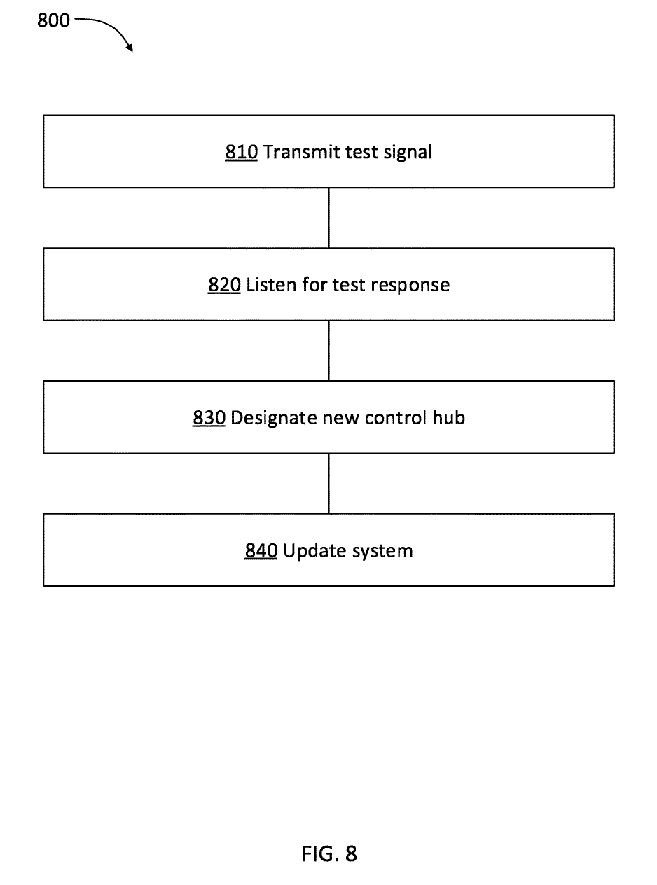

FIG. 8 depicts an example embodiment of a method for communicating over a redundant star network. Method 800 includes block 810. At block 810, a test signal is transmitted via a wireless long range transceiver. The test signal is designated for a current PD control hub. For example, in one embodiment, a central network hub transmits the test signal. Alternatively, another network hub transmits the test signal. At block 820, a test response signal is listened for via the wireless long range transceiver over an expected response timeframe after the test signal is transmitted. The test response signal includes data that indicates the test response signal was sent by the current PD control hub. At block 830, a new PD control hub is designated when the test response signal is not received within the expected response timeframe. At block 840, system operation instructions are updated with the new PD control hub designation. The system operation instructions are stored at the current PD control hub and the new PD control hub, and include PD operation instructions. In some embodiments, the new PD control hub transmits the test signal to test whether the old control hub is operational after the new control hub has taken over control of the PD. If the new control hub receives the test response signal from the old control hub within the expected timeframe, in some embodiments control of the PD is passed back to the old control hub.

In some embodiments, a central network hub transmits the test signal and stores the system operation instructions. The central network hub designates the new PD control hub from among two or more additional network hubs, and updates the system operation instructions with the new PD control hub designation. The two or more additional network hubs also store the system operation instructions.

In one specific embodiment of method 800, a network hub sends a test signal to a PD control hub and waits for a test response signal. When the test response signal is not received within an expected timeframe, the network hub updates the system operation instructions to take over control of the PD.

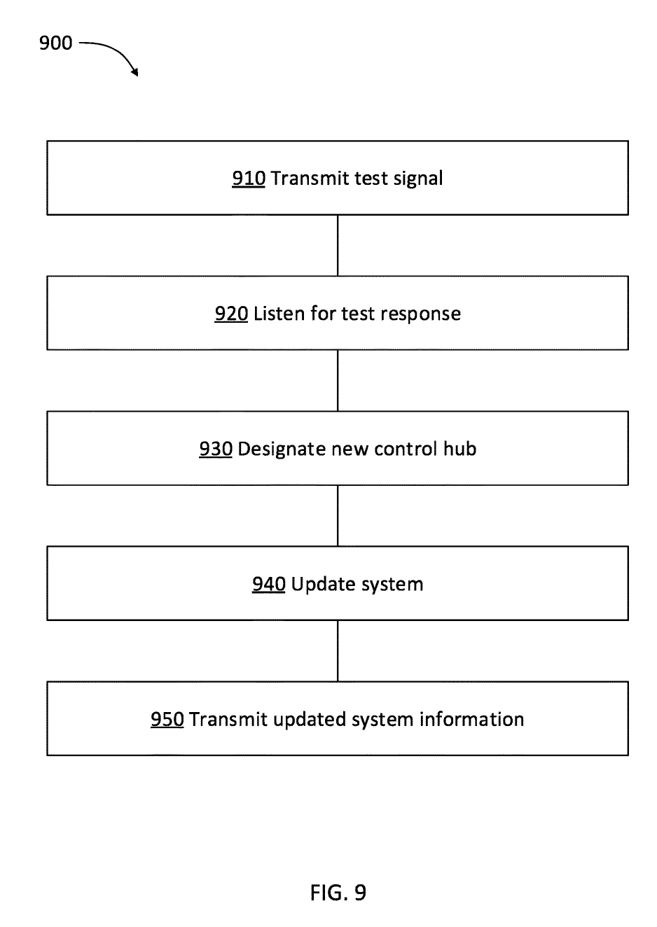

FIG. 9 depicts another example embodiment of a method for communicating over a redundant star network. Method 900 includes block 910. At block 910, a test signal is transmitted via a wireless long range transceiver. The test signal is designated for a current PD control hub. At block 920, a test response signal is listened for via the wireless long range transceiver over an expected response timeframe after the test signal is transmitted. The test response signal includes data that indicates the test response signal was sent by the current PD control hub. At block 930, a new PD control hub is designated when the test response signal is not received within the expected response timeframe. At block 940, system operation instructions are updated with the new PD control hub designation. The system operation instructions are stored at the current PD control hub and the new PD control hub, and include PD operation instructions. At block 950, the updated system operation instructions are transmitted, for example, from a central network hub to additional network hubs. The additional network hubs receive and store the updated system operation instructions.

1. A system comprising:
a peripheral device having a peripheral device wireless long range transceiver and a peripheral device microcontroller, wherein the peripheral device is controlled wirelessly by a peripheral device control hub;
a first network hub having a first wireless long range transceiver and a first microcontroller that stores system operation information, wherein the system operation information includes instructions for operating the peripheral device and instructions for designating the peripheral device control hub; and
a second network hub having a second wireless long range transceiver and a second microcontroller that stores the system operation information,
wherein the first microcontroller comprises:
second network hub test firmware, wherein the test firmware instructs the first network hub to send a second network hub test signal, and wherein the test firmware instructs the first network hub to listen for a second network hub test response signal; and
first network hub update firmware that instructs the first microcontroller to update the system operation information to designate the first network hub as the peripheral device control hub when the second network hub test response signal is not received within an expected response timeframe after the second network hub test signal is sent, and
wherein the second microcontroller comprises:
first network hub test firmware that instructs the second network hub to send a first network hub test signal and instructions that instruct the second network hub to listen for a first network hub test response signal; and
second network hub update firmware that instructs the second microcontroller to update the system operation information to designate the second network hub as the peripheral device control hub when the first network hub test response signal is not received within an expected response timeframe after the first network hub test signal is sent.

2. The system of claim 1, further comprising a server, wherein the server is one among a cloud of servers, wherein the server is networked to the first network hub, the second network hub, or both via a wired network connection, and wherein the server comprises hardware memory that stores the system operation information.

3. The system of claim 2, wherein the system operation information includes instructions that instruct the first network hub to notify the server:
the second network hub test response is not received; and
the first network hub is designated as the peripheral device control hub.

4. The system of claim 3, wherein the server hardware memory stores instructions that instruct the server to notify a user:
the second network hub test response is not received; and
the first network hub is designated as the peripheral device control hub.

5. The system of claim 2, wherein the system operation information includes instructions that instruct the second network hub to notify the server:
the first network hub test response is not received; and
the second network hub is designated as the peripheral device control hub.

6. The system of claim 5, wherein the server hardware memory stores instructions that instruct the server to notify a user:
the first network hub test response is not received; and
the second network hub is designated as the peripheral device control hub.

7. The system of claim 1, wherein one or more of the peripheral device microcontroller, the first microcontroller, or the second microcontroller comprise instructions for communicating long range spread spectrum signals, narrowband frequency shift keying signals, or both.

8. A system comprising:
a peripheral device having a peripheral device wireless long range transceiver and a peripheral device microcontroller, wherein the peripheral device is controlled wirelessly by a peripheral device control hub;
a central network hub having a wireless long range transceiver and a microcontroller that stores system operation information, wherein the system operation information comprises instructions for operating the peripheral device and instructions for designating a peripheral device control hub;
two or more additional network hubs, each having a wireless long range transceiver and a microcontroller that stores the system operation information, wherein the system operation information further comprises instructions for designating a new central network hub;
wherein the central network hub microcontroller comprises:
network hub test firmware that instructs the central network hub to send a test signal designated for a current peripheral device control hub and instructions that instruct the central network hub to listen for a current peripheral device control hub test response signal; and
peripheral device control hub update firmware that instructs the central network hub microcontroller to update the system operation information to designate a new peripheral device control hub from among the two or more additional network hubs when the current network hub test response signal is not received within an expected response timeframe after the current peripheral device control hub test signal is sent, and
wherein the additional network hub microcontrollers comprise:
central network hub test firmware that instructs the additional network hub to send a central network hub test signal designated for the central network hub and instructions that instruct the additional network hub to listen for a central network hub test response signal corresponding to the central network hub; and
additional network hub update firmware that instructs one or more of the additional microcontrollers to update the system operation information to designate one of the additional network hubs as the new central network hub when the central network hub test response signal is not received within an expected response timeframe after the central network hub test signal is sent.

9. The system of claim 8, further comprising a server, wherein the server is one among a cloud of servers, wherein the server is networked to the central network hub, one or more of the additional network hubs, or each of the central network hub and the additional network hubs via a wired network connection, and wherein the server comprises hardware memory that stores the system operation information.

10. The system of claim 9, wherein the system operation information includes instructions that instruct the central network hub to notify the server:
the current peripheral device control hub test response is not received; and
the new peripheral device control hub is designated.

11. The system of claim 10, wherein the server hardware memory stores instructions that instruct the server to notify a user:
the current peripheral device control hub test response is not received; and
the new peripheral device control hub is designated.

12. The system of claim 9, wherein the system operation information includes instructions that instruct one or more of the additional network hubs to notify the server:
the central network hub test response is not received; and
one of the additional network hubs is designated as the new central network hub.

13. The system of claim 12, wherein the server hardware memory stores instructions that instruct the server to notify a user:
the central network hub test response is not received; and
one of the additional network hub is designated as the new central network hub.

14. The system of claim 8, wherein one or more of the peripheral device microcontroller, the central network hub microcontroller, or the additional network microcontrollers comprise instructions for communicating long range spread spectrum signals, narrowband frequency shift keying signals, or both.

15. A method comprising:
transmitting, via a wireless long range transceiver, a test signal designated for a current peripheral device control hub;
listening, via the wireless long range transceiver, for a test response signal over an expected response timeframe after the test signal is transmitted, wherein the test response signal includes data that indicates the test response signal was sent by the current peripheral device control hub; and
designating a new peripheral device control hub when the test response signal is not received within the expected response timeframe;
updating system operation instructions with the new peripheral device control hub designation, wherein the system operation instructions are stored at the current peripheral device control hub and the new peripheral device control hub and wherein the system operation instructions include peripheral device operation instructions.

16. The method of claim 15, wherein the new peripheral device control hub transmits the test signal.

17. The method of claim 15, wherein a central network hub transmits the test signal, wherein the central network hub stores the system operation instructions, and wherein the central network hub designates the new peripheral device control hub, and wherein the central network hub updates the system operation instructions with the new peripheral device control hub designation.

18. The method of claim 17, wherein designating the new peripheral device control hub comprises selecting the new peripheral device control hub from among two or more additional network hubs, wherein the additional network hubs store the system operation instructions.

19. The method of claim 18, further comprising transmitting from the central network hub to the additional network hubs the updated system operation instructions.

20. The method of claim 19, further comprising receiving and storing at the additional network hubs the updated system operation instructions.
